(19) United States
(12) Patent Application Publication
(10) Pub. No.: US 2025/0211699 A1
(43) Pub. Date: Jun. 26, 2025

(54) MOBILE TERMINAL SYSTEM, INFORMATION DEVICE SYSTEM, AND NON-TRANSITORY COMPUTER READABLE MEDIUM

(71) Applicant: FUJIFILM Business Innovation Corp., Tokyo (JP)

(72) Inventor: Satoshi KAWAMURA, Kanagawa (JP)

(73) Assignee: FUJIFILM Business Innovation Corp., Tokyo (JP)

(21) Appl. No.: 18/734,369

(22) Filed: Jun. 5, 2024

(30) Foreign Application Priority Data
Dec. 22, 2023 (JP) 2023-217210

(51) Int. Cl. H04N 1/44; G06F 3/14; H04N 1/00

(52) U.S. Cl. CPC H04N 1/4433; H04N 1/00204; H04N 1/00307; H04N 1/00493; H04N 1/4413; G06F 3/1454; H04N 2201/0094

(57) ABSTRACT

A mobile terminal system includes one or more processors configured to: establish connection, using connection information, with an information device system executing a remote operation mode under which an operation screen of the information device system is mirrored on a terminal screen to enable a remote operation on the operation screen; log in to the information device system using login information input and storing the login information; store an operation history of the terminal screen; and when the information device system is restarted and the connection is released, reconnect to the restarted information device system using the connection information, log in to the information device system using the login information stored, and restore the terminal screen at a timing of the release using the operation history stored.

### CROSS-REFERENCE TO RELATED APPLICATIONS

This application is based on and claims priority under 35 USC 119 from Japanese Patent Application No. 2023-217210 filed Dec. 22, 2023.

### BACKGROUND

### (i) Technical Field

The present disclosure relates to a mobile terminal system, an information device system, and a non-transitory computer readable medium.

### (ii) Related Art

Japanese Unexamined Patent Application Publication No. 2019-201322 discloses a technique related to a remote maintenance system and an information processing method. In this related art, an image forming apparatus stores, in a memory of the image forming apparatus, user login information and a first interruption screen for resuming from an interrupted point in response to reconnection. A user is automatically logged in based on the user login information after restart processing. When wireless communication connection with a mobile terminal is completed, the screen of the image forming apparatus transitions to the first interruption screen. The mobile terminal stores, in a memory of the mobile terminal, authentication information for wireless communications with the image forming apparatus and a second interruption screen for resuming from an interrupted point in response to reconnection. When a reconnection button is selected, the mobile terminal establishes the wireless communication connection with the image forming apparatus based on the authentication information, and a screen of the mobile terminal transitions to the second interruption screen.

### SUMMARY

When an operator such as an administrator operates an operation screen of an information device to change various settings, restart may be required. However, when the information device is restarted, it is necessary to perform, after the restart, an operation for restoring the operation screen before the restart, resulting in increased number of operations.

Aspects of non-limiting embodiments of the present disclosure relate to reducing the number of operations of an operator as compared with a case where the operator performs an operation to restore an operation screen of an information device system after restart.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a mobile terminal system including one or more processors configured to:
establish connection, using connection information, with an information device system executing a remote operation mode under which an operation screen of the information device system is mirrored on a terminal screen to enable a remote operation on the operation screen:
log in to the information device system using login information input and store the login information,
store an operation history of the terminal screen;
when the information device system is restarted and the connection is released,
   reconnect to the restarted information device system using the connection information;
   log in to the information device system using the login information stored; and
   restore the terminal screen at a timing of the release using the operation history stored.

### BRIEF DESCRIPTION OF THE DRAWINGS

An exemplary embodiment of the present disclosure will be described in detail based on the following figures, wherein:

FIG. 1 is a schematic configurational view of a remote operation system;

FIG. 2 is a block diagram of a hardware configuration of an image forming apparatus;

FIG. 3 is a block diagram of a control unit of the image forming apparatus;

FIG. 4 is a block diagram of a hardware configuration of a mobile terminal device;

FIG. 5 is a block diagram of a control unit of the mobile terminal device;

FIG. 6 is a sequence diagram of the remote operation system;

FIG. 7 is a flowchart illustrating a flow of processing executed when a remote operation program is activated in the image forming apparatus;

FIG. 8 is a flowchart illustrating a flow of processing in the image forming apparatus at the time of logout;

FIG. 9 is a flowchart illustrating a flow of processing executed in the image forming apparatus at the time of restarting;

FIG. 10 is a flowchart illustrating a flow of processing executed when a setting of a first communication interface is changed in the image forming apparatus;

FIG. 11 is a flowchart illustrating a flow of processing executed when a remote operation application is activated in the mobile terminal device;

FIG. 12 is a flowchart illustrating a flow of processing executed in the mobile terminal device at the time of logout;

FIG. 13 is a flowchart illustrating a flow of processing executed in the mobile terminal device at the time of restart;

FIGS. 14 consists of (A) and (B) that are sequence diagrams in which a plurality of image forming apparatuses are remotely operated; and

FIG. 15 is a block diagram of a hardware configuration of a server.

### DETAILED DESCRIPTION

### Exemplary Embodiment

In the following, an example of an embodiment for carrying out the technique of the present disclosure will be described with reference to the drawings. Note that components and processing with the same operation, effect, and function are denoted by the same reference signs throughout the drawings, and redundant description may be omitted or simplified as appropriate. Each drawing is merely schematically illustrated to the extent that the technique of the present disclosure can be sufficiently understood. Therefore, the technique of the present disclosure is not limited only to the examples illustrated in the drawings. Furthermore, in the present exemplary embodiment, a description of a configuration not directly related to the present disclosure, a known configuration, or the like may be omitted or simplified.

### Remote Operation System

First of all, a schematic configuration of a remote operation system will be described.

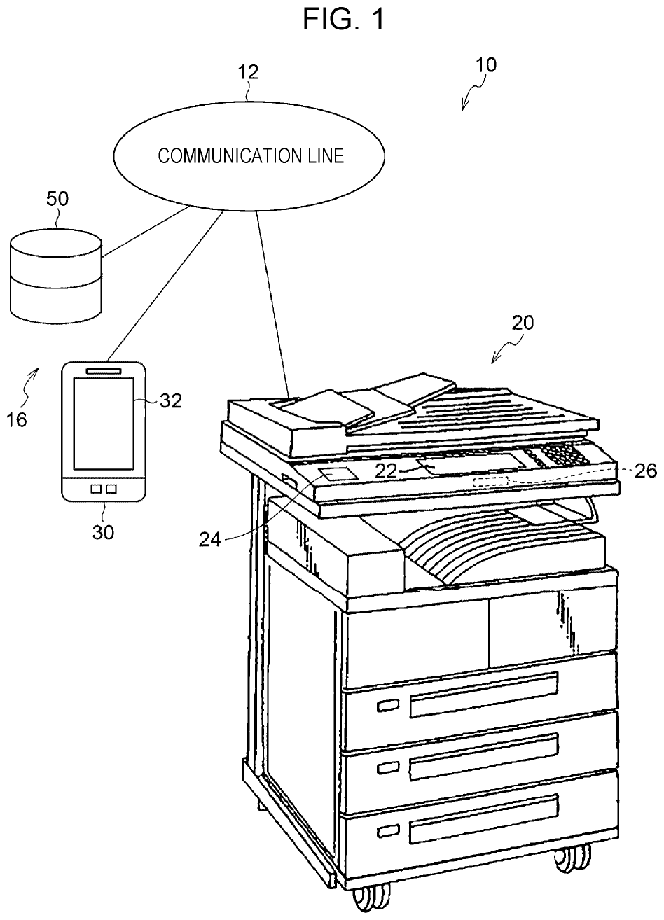

As illustrated in FIG. 1, a remote operation system 10 according to the present exemplary embodiment includes an image forming apparatus 20 as an example of an information device system, and a mobile terminal device 30 and a server 50 which form a mobile terminal system 16. The mobile terminal device 30 is a mobile information device that can be carried around and used and can be used while being held in a hand or worn on a body, and is, for example, a laptop computer, a smartphone, a tablet terminal, or the like.

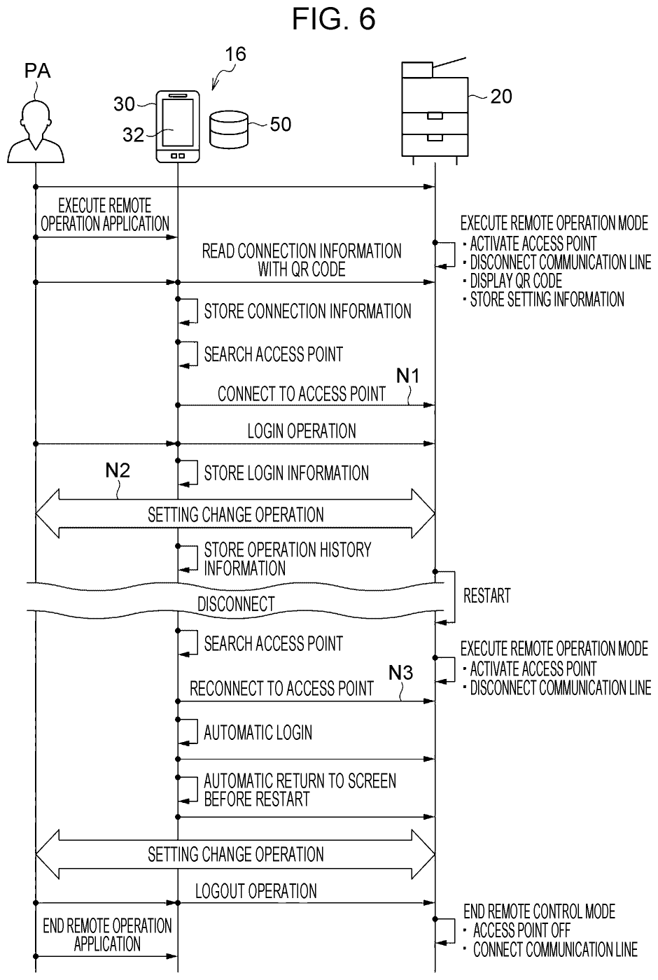

In the remote operation system 10 according to the present exemplary embodiment, an operation screen 22, which will be described later, of the image forming apparatus 20 is mirrored on a terminal screen 32, which will be described later, of the mobile terminal device 30 directly connected to the image forming apparatus 20. Next, an operator PA (see FIG. 6) operates the mirrored terminal screen 32 to remotely operate the operation screen 22 and change the settings of the image forming apparatus 20.

The image forming apparatus 20 is provided with a remote operation mode under which the operation screen 22 is mirrored on the terminal screen 32 of the mobile terminal device 30 so as to be remotely operable. Similarly, the mobile terminal device 30 has a remote operation application installed with which the operation screen 22 of the image forming apparatus 20 is mirrored on the terminal screen 32 to be remotely operable. Note that mirroring in the present exemplary embodiment is about displaying the same screen on the operation screen 22 and on the terminal screen 32 to enable a remote operation on the terminal screen 32, and is implemented using a technique such as VNC.

### Image Forming Apparatus

Next, the image forming apparatus of the present exemplary embodiment will be described.

The image forming apparatus 20 is what is known as multifunction peripheral having a printing function of receiving various types of data and the like via a communication line 12 such as a Local Area Network (LAN) and executing image forming processing based on the received data, a reading function of reading a document to obtain image information representing the document, a copying function of copying an image recorded on the document onto a recording medium such as a sheet of paper, a facsimile function of transmitting and receiving various types of data via a telephone line (not shown), and the like.

The image forming apparatus 20 is provided with the touch panel type operation screen 22 which implements acceptance of various instruction operations by a user with a software program and displays various types of information and the like. The operation screen 22, implements acceptance of various instruction operations by the user, and displays various types of information and the like. The operation screen 22 can display a matrix-type two-dimensional code such as a QR code (registered trademark).

Further, the image forming apparatus 20 is provided with an IC card reader 24 employing Near Field Communication (NFC) or the like. The IC card reader 24 performs short-range wireless communications to transmit and receive information to and from a non-contact type IC card.

Further, an access point 26 employing Wi-Fi Direct or the like is provided inside the image forming apparatus 20 of the present exemplary embodiment. The access point 26 is dedicated to a remote operation under the remote operation mode, and can be directly connected with the above-described mobile terminal device 30. While the access point 26 of the present exemplary embodiment is dedicated to the remote operation as described above, the image forming apparatus 20 may include a general access point other than the access point dedicated to the remote operation.

Next, the hardware configuration of the image forming apparatus according to the present exemplary embodiment will be described.

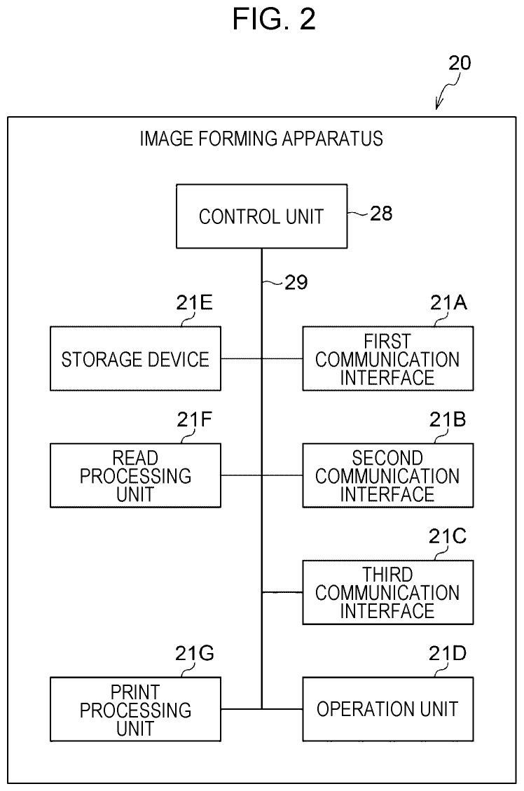

As illustrated in FIG. 2, the image forming apparatus 20 includes a first communication interface 21A, a second communication interface 21B, a third communication interface 21C, an operation unit 21D, a storage device 21E, a reading processing unit 21F, a printing processing unit 21G, and a control unit 28, which are electrically connected to each other by a system bus 29.

The first communication interface 21A is a communication interface for connecting the image forming apparatus 20 to the communication line 12 (see FIG. 1). The second communication interface 21B is a communication interface for establishing direct connection with the mobile terminal device 30 (see FIG. 1) using the access point 26 (see FIG. 1). The third communication interface 21C is a communication interface for establishing short-range wireless communication connection with a non-contact type IC card of the mobile terminal device 30 (see FIG. 1) using a card reader 24 (see FIG. 1).

The operation unit 21D executes processing related to an operation on the operation screen 22 (see FIG. 1). The storage device 21E includes a hard disk drive (HDD), a solid state drive (SSD), and the like, and stores various types of data, programs for the remote operation mode or the like, and the like. The reading processing unit 21F executes processing related to the reading function of the image forming apparatus 20. The printing processing unit 21G executes processing related to the printing function and the copying function of the image forming apparatus 20.

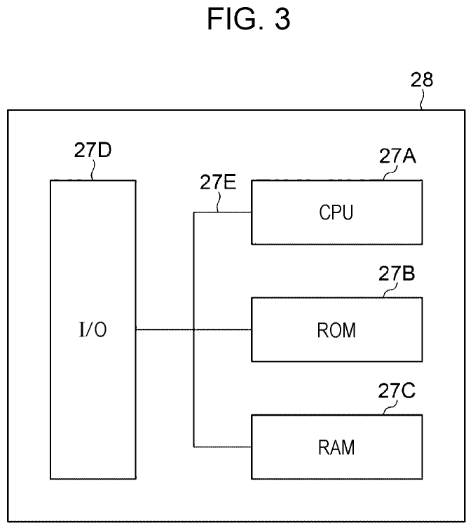

As illustrated in FIG. 3, the control unit 28 includes a central processing unit (CPU) 27A that executes various types of processing in the image forming apparatus 20, a read only memory (ROM) 27B that stores various programs, a random access memory (RAM) 27C that is used as a temporary work area of the CPU 27A, and an input/output interface (I/O) 27D. The CPU 27A, the ROM 27B, the RAM 27C, and the I/O 27D are connected to each other via a bus 27E. The first communication interface 21A, the second communication interface 21B, the third communication interface 21C, the operation unit 21D, the storage device 21E, the reading processing unit 21F, and the printing processing unit 21G, which are illustrated in FIG. 2 described above, are electrically connected to the I/O 27D by the system bus 29.

The CPU 27A, which is an example of the processor and is illustrated in FIG. 3, is a central processing unit and governs the overall operation of the image forming apparatus 20. The CPU 27A executes various programs for the remote operation mode and the like, and controls each unit. Specifically, the CPU 27A reads a program from the ROM 27B or the storage device 21E (see FIG. 2), and executes the program using the RAM 27C as a work area.

### Mobile Terminal Device

Next, the mobile terminal device of the present exemplary embodiment will be described.

As illustrated in FIG. 1, the mobile terminal device 30 is a smartphone or a tablet terminal having the front surface provided with the touch panel type terminal screen 32. The mobile terminal device 30 includes a camera, a speaker, a microphone, and the like, which are not illustrated, and incorporates the non-contact type IC card.

The mobile terminal device 30 can be used with various application programs installed therein. When executing an application program, the mobile terminal device 30 according to the present exemplary embodiment may operate in cooperation with the server 50 connected to the communication line 12.

In the present exemplary embodiment, as described above, when a remote operation application for remotely operating the image forming apparatus 20 is installed in the mobile terminal device 30, the operator PA (see FIG. 6) can remotely operate the operation screen 22 of the image forming apparatus 20 and change various settings by operating the terminal screen 32 of the mobile terminal device 30.

Next, a hardware configuration of the mobile terminal device of the present exemplary embodiment will be described.

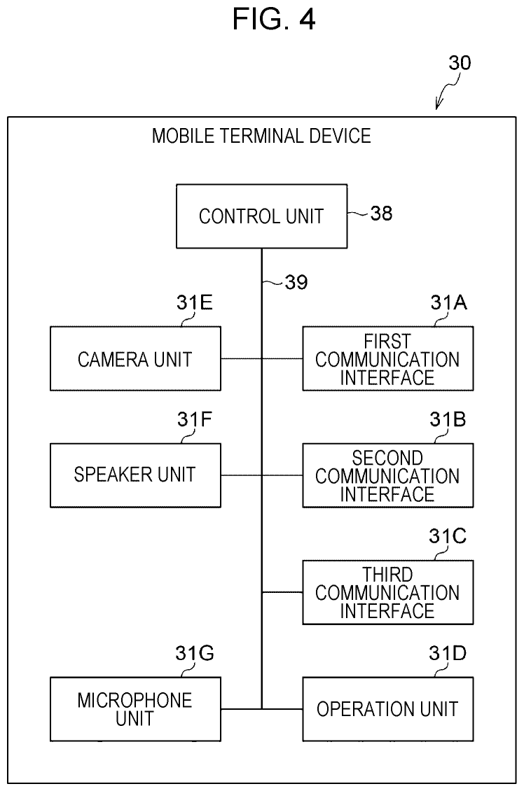

As illustrated in FIG. 4, the mobile terminal device 30 includes a first communication interface 31A, a second communication interface 31B, a third communication interface 31C, an operation unit 31D, a camera unit 31E, a speaker unit 31F, a microphone unit 31G, and a control unit 38, which are electrically connected to each other by a system bus 39.

The first communication interface 31A is a communication interface for connecting the mobile terminal device 30 to the communication line 12 (see FIG. 1). The second communication interface 31B is a communication interface for establishing direct connection with the access point 26 (see FIG. 1) of the image forming apparatus 20. The third communication interface 31C is a communication interface for establishing short-range wireless communication connection with the card reader 24 (see FIG. 1) of the image forming apparatus 20 using the built-in non-contact type IC card.

The operation unit 31D executes processing related to an operation on the terminal screen 32 (see FIG. 1). The camera unit 31E executes processing related to a camera function of the mobile terminal device 30. The speaker unit 31F executes processing related to a speaker function of the mobile terminal device 30. The microphone unit 31G performs processing related to a microphone function of the mobile terminal device 30.

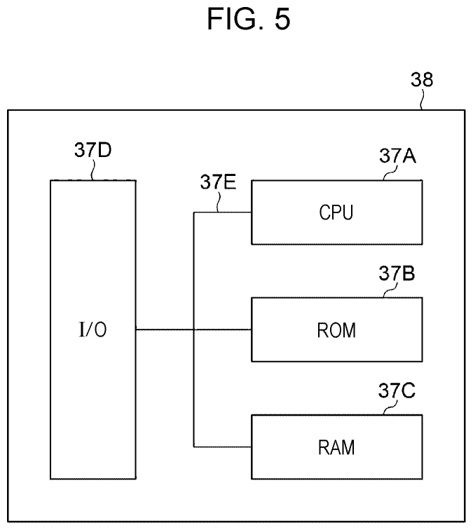

As illustrated in FIG. 5, the control unit 38 includes a central processing unit (CPU) 37A for executing various types processing in the mobile terminal device 30, a read only memory (ROM) 37B for storing various programs such as a remote operation application, a random access memory (RAM) 37C used as a temporary work area of the CPU 37A, and an input/output (I/O) interface 37D. The CPU 37A, the ROM 37B, the RAM 37C, and the I/O 37D are connected to each other via a bus 37E. The first communication interface 31A, the second communication interface 31B, the third communication interface 31C, the operation unit 31D, the camera unit 31E, the speaker unit 31F, and the microphone unit 31G, which are illustrated in FIG. 4 described above, are electrically connected to the I/O 37E by the system bus 39.

The CPU 37A, which is an example of the processor and is illustrated in FIG. 5, is a central processing unit and governs the overall operation of the mobile terminal device 30. The CPU 37A executes various programs such as the remote operation application, and controls each unit. Specifically, the CPU 37A reads a program from the ROM 37B and executes the program using the RAM 37C as a work area.

### Server

Next, the server 50 of the present exemplary embodiment will be described.

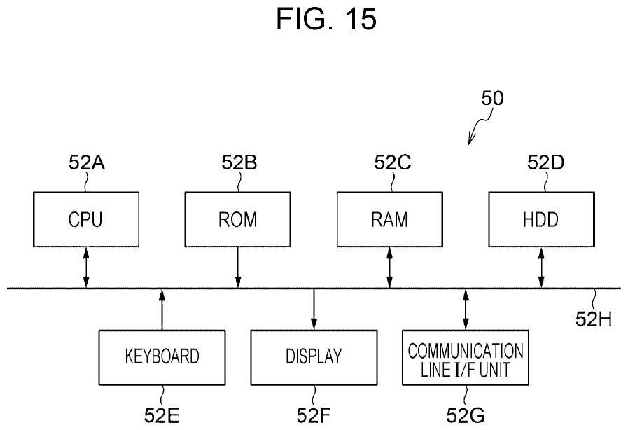

FIG. 15 is a block diagram illustrating a configuration of a main part of an electrical system of the server 50 according to the present exemplary embodiment. The server 50 basically has the same configuration as a general computer.

The server 50 includes a CPU 52A, a ROM 52B, a RAM 52C, an HDD 52D, a keyboard 52E, a display 52F, a communication line interface (I/F) unit 52G, and the like.

The CPU 52A governs the overall operation of the server 50. Various control programs, various parameters, and the like are stored in advance in the ROM 52B. The RAM 52C is used as a work area or the like for the CPU 52A to execute various programs. Various types of data, application programs, and the like are stored in the HDD 52D. The keyboard 52E is used for inputting various types of information. The display 52F is used to display various types of information. The communication line I/F unit 52G is connected to the communication line 12 (see FIG. 1) and transmits and receives various types of data to and from other devices such as the mobile terminal device 30 connected to the communication line 12. These units of the server 50 are electrically connected to each other by a system bus 52H.

In the server 50 according to the present exemplary embodiment, the HDD 52D is used as a storage unit, but this should not be construed in a limiting sense, and another nonvolatile storage unit such as a flash memory may be used.

With the above-described configuration, the server 50 executes, with the CPU 52A, access to the ROM 52B, the RAM 52C, and the HDD 52D, acquisition of various types of data via the keyboard 52E, and display of various types of information on the display 52F. Further, the server 50 controls, with the CPU 52A, transmission and reception of communication data via the communication line I/F unit 52G.

### Remote Operation

Next, a description will be given on a setting change in which various settings of the image forming apparatus 20 in the remote operation system 10 of the present exemplary embodiment illustrated in FIG. 1 are changed through remote operations from the mobile terminal device 30. Note that the various settings for changing the image forming apparatus 20 are important settings to be made by the operator PA (see FIG. 6) such as an administrator who manages the image forming apparatus 20, and for example, are authentication method settings, communication settings, device option configuration settings, and the like.

Further, as described above, for the setting change through the remote operation on the image forming apparatus 20 using the remote operation system 10, the operation screen 22 is mirrored on the terminal screen 32 of the mobile terminal device 30 connected to the image forming apparatus 20. Next, the operator PA (FIG. 6) remotely operates the operation screen 22 by operating the terminal screen 32 to change the setting. Furthermore, the operator activates the remote operation mode of the image forming apparatus 20 and activates the remote operation application of the mobile terminal device 30 to perform the remote operation.

### Overall Processing Flow

First, an overall flow for changing various settings of the image forming apparatus 20 through a remote operation using the mobile terminal device 30 will be described with reference to FIG. 6. Note that the remote operation flow in FIG. 6 proceeds from top to bottom. Furthermore, this flow is merely an example and is not limiting.

As illustrated in FIG. 6, the operator PA such as an administrator who manages the image forming apparatus 20 goes to the vicinity of the image forming apparatus 20 whose setting is to be changed, operates the operation screen 22 (see FIG. 1), and activates and executes the remote operation mode. In the image forming apparatus 20, when the remote operation mode is executed, the connection with the communication line 12 is released and the access point 26 dedicated to the remote mode is activated. Since the connection with the communication line 12 is released, the image forming apparatus 20 is in a state of not accepting a print job or the like from an external device such as a personal computer via the communication line 12. The image forming apparatus 20 stores various types of setting information at the time when the remote operation mode is executed. That is, the setting information before the setting change to be made by the operator PA is stored.

Furthermore, in the image forming apparatus 20, a matrix-type two-dimensional code with connection information for connecting to the access point 26 is displayed on the operation screen 22. The connection information is a Service Set IDentifier (SSID), a password, and the like.

The operator PA operates the terminal screen 32 of the mobile terminal device 30 to activate and execute the remote operation application. When the remote operation application is activated, the operator PA reads the matrix-type two-dimensional code displayed on the operation screen 22 with a camera (not illustrated) of the mobile terminal device 30 and acquires the connection information. The mobile terminal device 30 performs polling search with the read connection information and connects to the access point 26 (step NI described later). The mobile terminal device 30 stores the acquired connection information.

Once the mobile terminal device 30 is connected to the access point 26, the matrix-type two-dimensional code with the connection information displayed on the operation screen 22 of the image forming apparatus 20 disappears.

Until the connection with the access point 26 is established, the terminal screen 32 of the mobile terminal device 30 displays a standby message such as “Currently connected to access point. Please wait”. The standby message disappears once the connection is established. Thus, while the polling search is in progress, the above-described standby message is displayed on the terminal screen 32.

The operator PA operates the terminal screen 32 of the mobile terminal device 30 to input login information and log in to the image forming apparatus 20 in which the remote operation mode is active. Further, the mobile terminal device 30 stores the input login information. The login information is an ID, a password, and the like. It should be noted that the image forming apparatus 20 is configured not to be able to log in using information other than login information registered in advance. In the present exemplary embodiment, the login information registered in advance is an ID and a password of the operator PA such as an administrator who has authority to remotely operate the image forming apparatus 20.

When the mobile terminal device 30 logs in to the image forming apparatus 20 in which the remote operation mode is active, the operation screen 22 (see FIG. 1) of the image forming apparatus 20 is mirrored on the terminal screen 32 of the mobile terminal device 30. The operator PA then operates the terminal screen 32 of the mobile terminal device 30 to remotely operate the operation screen 22 of the image forming apparatus 20 and change various settings of the image forming apparatus 20 (step N2 described later). The mobile terminal device 30 stores the terminal screen 32, that is, stores the operation history information of the terminal screen 32 every time the terminal screen 32 is operated and the terminal screen 32 is changed.

In the present exemplary embodiment, the connection information, the login information, and the operation history information described above are stored in the server 50 that executes the remote operation application in cooperation with the mobile terminal device 30.

In the above-described step N2 in FIG. 6 in which the operator PA operates the terminal screen 32 of the mobile terminal device 30 to remotely operate the operation screen 22 of the image forming apparatus 20 for the setting change, restart may be required, after the setting of the image forming apparatus 20 has been changed, in order to reflect the changed content. In such a case, the operator PA issues an instruction to restart the image forming apparatus 20 from the terminal screen 32 of the mobile terminal device 30.

The setting change requiring the restart is, for example, that for authentication method setting, communication setting, device option configuration setting, and the like. In the present exemplary embodiment, while the remote operation mode is active, the connection with the communication line 12 is not established unless temporary connection described later is established. Therefore, no setting change is performed with a program or the like downloaded to the image forming apparatus 20 via the communication line 12.

When the image forming apparatus 20 restarts upon accepting a restart instruction, the access point 26 (see FIG. 1) is temporarily deactivated and then restarts. The remote operation mode is re-executed in response to the restart. Still, the operation screen 22 (refer to FIG. 1) returns to the home screen.

On the other hand, the mobile terminal device 30 is disconnected from the access point 26 when the image forming apparatus 20 restarts. When the connection with the access point 26 is released, the mobile terminal device 30 executing the remote operation application performs polling search with the connection information stored in the server 50 and reconnects to the access point 26. Note that, as with the first time, until the reconnection with the access point 26 is established, the terminal screen 32 displays a standby message such as “Currently connected to access point. Please wait.” The standby message disappears once the connection is established.

When reconnecting to the access point 26, the mobile terminal device 30 executing the remote operation application re-logs in to the image forming apparatus 20 under the remote operation mode using the login information stored in the server 50. After the re-log in, the mobile terminal device 30 restores the terminal screen 32 before the restart using the operation history information stored in the server 50. Accordingly, the mirrored operation screen 22 of the image forming apparatus 20 also returns to the screen before the restart.

Thus, after the image forming apparatus 20 is restarted, the mobile terminal device 30 executing the remote operation mode automatically reconnects to the access point 26 (step N3 to be described later) and re-logs in. Then, the mobile terminal device 30 traces back to the screen before the restart based on the operation history information and restores the state before the restart.

The operator PA operates the terminal screen 32 of the mobile terminal device 30 again, and thus operates the operation screen 22 of the image forming apparatus 20 to continue the setting change for various settings. Note that in the case of restarting in order to reflect the changed content again thereafter, the above is repeated.

When the setting change operation ends, the operator PA operates the terminal screen 32 of the mobile terminal device 30 to log out and end the remote operation application. When the mobile terminal device 30 logs out, the image forming apparatus 20 automatically ends the execution of the remote operation mode, disconnects from the access point 26, and connects to the communication line 12 (see FIG. 1).

Next, a description will be given on processing executed when the operator PA changes the setting for the first communication interface 21A (see FIG. 2) of the image forming apparatus 20 in step N3 in FIG. 6.

When the operator PA changes the setting for the first communication interface 21A in step N3 in FIG. 6, the image forming apparatus 20 displays “change setting” and “perform communication test” on the operation screen 22 to be selected by the operator PA. Note that at this point, the setting of the first communication interface 21A is not changed. Furthermore, “change setting” and “perform communication test” are also similarly displayed on the terminal screen 32 mirrored.

When the operator PA selects “change setting” on the terminal screen 32, the image forming apparatus 20 executes setting change processing. When the operator PA selects “perform communication test,” the image forming apparatus 20 performs a communication test.

Specifically, the image forming apparatus 20 temporarily connects to the communication line 12 (see FIG. 1) and performs communication check with the setting of the first communication interface 21A changed. Then, the communication result is displayed on the operation screen 22 together with display prompting the user to select “change setting” or “reset”, and the connection to the communication line 12 released.

While the remote operation mode is being executed, a job such as a print job from a personal computer connected to the communication line 12 is not accepted. Specifically, for example, the acceptance of the job is disabled through closing of a port of the first communication interface 21A through which the job is accepted or the like.

The operator PA checks the result on the terminal screen 32 of the mobile terminal device 30 on which the operation screen 22 is mirrored. If the result is satisfactory, “change setting” is selected, and the image forming apparatus 20 accepts the selection and executes the setting change processing. When “reset” is selected, the operator PA changes the setting for the first communication interface 21A again. The image forming apparatus 20 displays “change setting” and “perform communication test” again.

Next, processing in a case where the mobile terminal device 30 fails to be connected to the access point 26 (see FIG. 1) dedicated to the remote mode of the image forming apparatus 20 for some reason in step N1 and step N3 of FIG. 6 will be described. Note that the same processing is executed when the access point 26 dedicated to the remote mode fails to be activated for some reason.

If the mobile terminal device 30 fails to be connected to the access point 26 dedicated to the remote mode for a set time set in advance (for example, about two minutes), a time-out occurs, and the image forming apparatus 20 ends the execution of the remote operation mode, the connection with the access point 26 is released, and the connection with the communication line 12 is established. Furthermore, the image forming apparatus 20 changes various settings based on the stored setting information and restarts.

Note that since the setting is not changed when the time-out occurs in step N1 in FIG. 6, the setting change is not reflected, and thus the setting remains to be the same even if various settings are changed based on the stored setting information. However, when the time-out occurs in step N3 in FIG. 6 after the restart, while the setting change has been made until then, various settings return to the settings before the execution of the remote operation mode based on the setting information stored.

On the other hand, the time-out also occurs when the mobile terminal device 30 fails to be connected to the access point 26 dedicated to the remote mode even after a lapse of a set time set in advance (for example, about one minute). As a result, instead of the message “Connected to access point. Please wait”, an end message such as “Connection to access point failed” is displayed. It is desirable that the set time for the time-out of the mobile terminal device 30 is equal to or shorter than the set time for the time-out of the image forming apparatus 20.

In addition to the end message such as “connection to access point failed”, a guide message for guiding a countermeasure may also be displayed. The guide message is, for example, display indicating that, if the time-out occurs, the remote operation mode ends and the image forming apparatus 20 automatically returns to the setting before the execution of the remote operation mode. Alternatively, display may be provided prompting the user to perform a restoration operation by operating the operation screen 22 of the image forming apparatus 20.

### Processing in Image Forming Apparatus

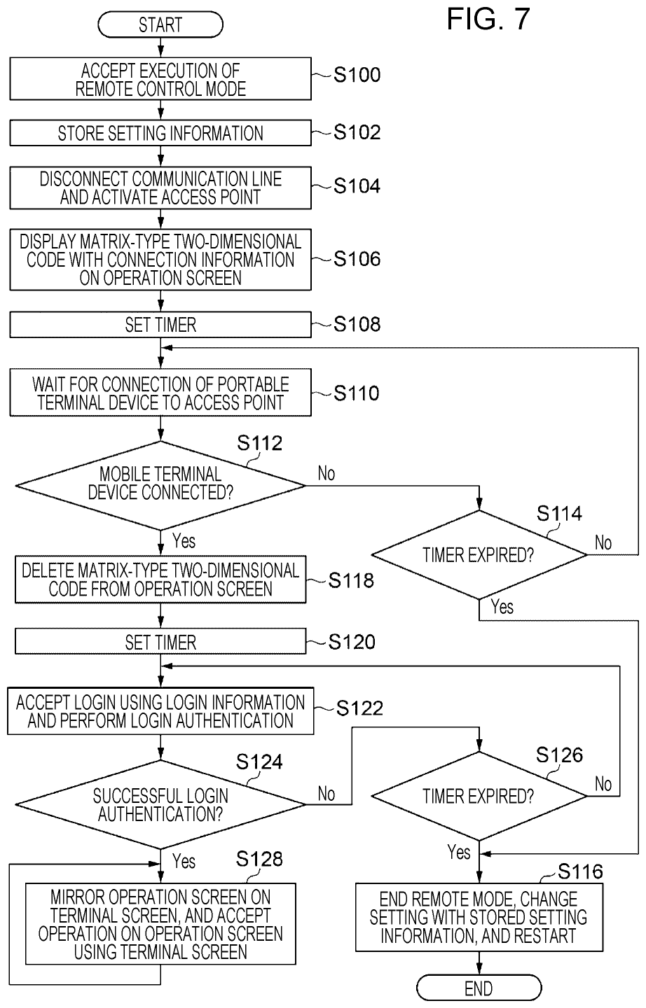

Next, remote operation processing in the image forming apparatus 20 will be described with reference to a flowchart in FIG. 7.

First of all, in step S100, the CPU 27A (see FIG. 3) of the control unit 28 of the image forming apparatus 20 (see FIG. 1) accepts the operation on the operation screen 22 (see FIG. 1) by the operator PA to execute the remote operation mode (see FIG. 6). In step S102, the CPU 27A stores various types of setting information at the current point.

In step S104, the CPU 27A releases the connection with the communication line 12 (see FIG. 1) and activates the access point 26 dedicated to the remote mode. In step S106, the CPU 27A displays a matrix-type two-dimensional code with connection information for connecting to the access point 26 on the operation screen 22 (see FIG. 1).

In step S108, the CPU 27A sets a timer. In step S110, the CPU 27A waits for connection of the mobile terminal device 30 to the access point 26. In step S112, the CPU 27A checks whether the mobile terminal device 30 is connected to the access point 26. If the connection is not established (No), the processing proceeds to step S114.

In step S114, the CPU 27A checks whether the timer has expired. When the timer has not expired yet (No), the processing returns to step S110. When the timer has expired in step S114 (Yes), the processing proceeds to step S116. In step S116, the CPU 27A ends the remote operation mode, changes the setting with the setting information stored in step S102, and implements the restart.

In step S112 described above, when the mobile terminal device 30 is connected to the access point 26 (Yes), the CPU 27A proceeds to step S118. In step S118, the CPU 27A deletes the matrix-type two-dimensional code on the operation screen 22. In step S120, the CPU 27A sets a timer. In step S122, the CPU 27A accepts login using login information from the mobile terminal device 30 (see FIG. 1) and performs login authentication. In step S124, the CPU 27A determines whether the login authentication is successful. When the login authentication fails (No), the processing proceeds to step S126.

In step S126, the CPU 27A checks whether the timer has expired. When the timer has not expired yet (No), the processing returns to step S122. When the timer has expired (Yes), the processing proceeds to step S116. In step S116, the CPU 27A ends the remote operation mode, changes the setting with the setting information stored in step S102, and implements the restart.

When the login authentication is successful in step S124 (Yes), the processing proceeds to step S128. In step S128, the CPU 27A mirrors the operation screen 22 on the terminal screen 32 (see FIG. 1), and accepts an operation on the operation screen 22 using the terminal screen 32.

As will be described later, when a logout instruction is accepted and the logout occurs, the remote operation mode ends. Alternatively, when the mobile terminal device 30 is not reconnected to the image forming apparatus 20 after the restart in response to acceptance of the restart instruction, the remote operation mode ends. Until then, step S128 is repeated.

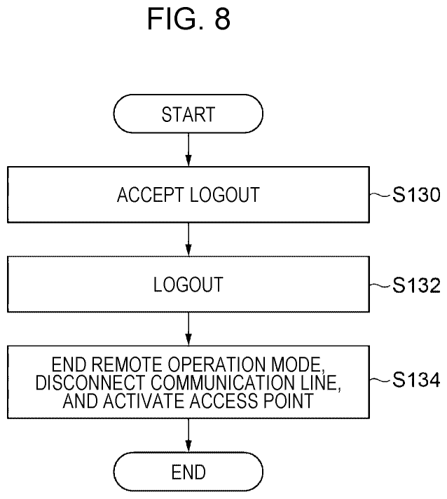

Next, a case where a logout instruction is accepted in step S128 (see FIG. 7) will be described with reference to a flowchart in FIG. 8.

In step S130, the CPU 27A accepts the logout instruction through an operation on the operation screen 22 (see FIG. 1) made through a remote operation performed using the terminal screen 32. In step S132, the CPU 27A logs out. In step S134, the CPU 27A ends the execution of the remote operation mode, releases the connection with the access point 26 dedicated to the remote mode, and establishes the connection with the communication line 12 (see FIG. 1).

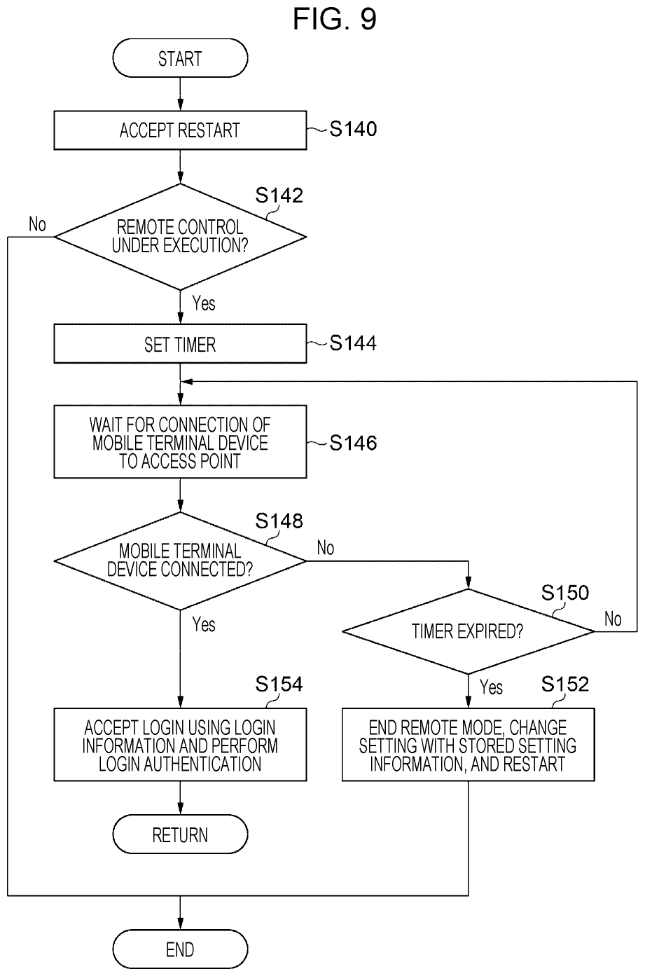

Next, a description will be given, with reference to a flowchart in FIG. 9, on processing executed when, in step S128 (see FIG. 7), a restart instruction is accepted and the restart is implemented.

After the restart, in step S140, the CPU 27A accepts the restart instruction and implements the restart. After the restart, in step S142, the CPU 27A checks whether the remote operation mode is active. When the remote operation mode is not active (No), the processing ends. When the remote mode is active (Yes), the processing proceeds to step S144.

In step S144, the CPU 27A sets a timer. In step S146, the CPU 27A waits for connection of the mobile terminal device 30 (see FIG. 1) to the access point 26 (see FIG. 1). In step S148, the CPU 27A checks whether the mobile terminal device 30 is connected to the access point 26. When the connection is not established (No), the processing proceeds to step S150.

In step S150, the CPU 27A checks whether the timer has expired. When the timer has not expired yet (No), the processing returns to step S146. When the timer has expired in step S150 (Yes), the processing proceeds to step S152. In step S152, the CPU 27A ends the remote operation mode, changes the setting with the setting information stored in step S102 (see FIG. 7), and implements the restart.

In step S148 described above, when the mobile terminal device 30 is connected to the access point 26 (Yes), the CPU 27A proceeds to step S154. In step S154, the CPU 27A accepts login using login information from the mobile terminal device 30 (see FIG. 1), performs login authentication, and then returns to step S128 (see FIG. 7).

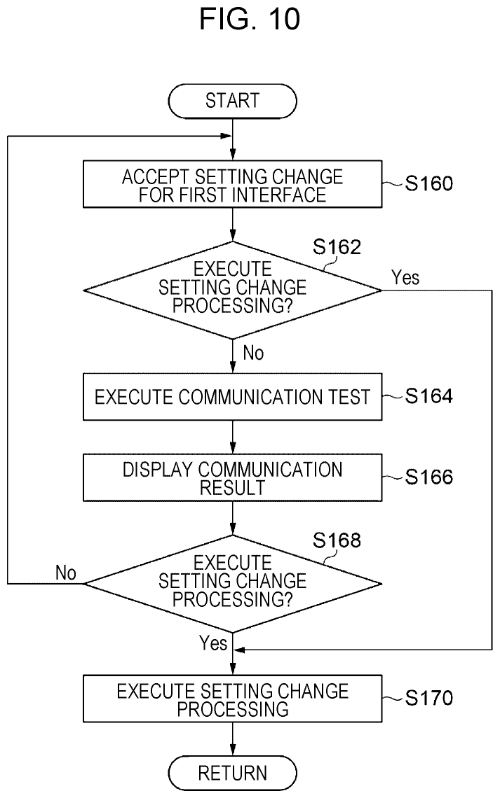

Next, processing in a case where setting change for the first communication interface 21A (see FIG. 2) is accepted in step S128 (see FIG. 7) will be described with reference to a flowchart in FIG. 10.

In step S160, the CPU 27A accepts the setting change for the first communication interface 21A. In step S162, the CPU 27A checks whether to reflect the setting change and execute the setting change processing. Note that at this point, “change setting” or “perform communication test” is displayed on the operation screen 22 and the terminal screen 32 to be selected (see FIG. 1).

When “change setting” is selected (Yes), the processing proceeds to step S170, and the CPU 27A executes the setting change processing for the first communication interface 21A. When “perform communication test” is selected, that is, when the setting is not to be changed (No), the processing proceeds to step S164.

In step S164, the CPU 27A performs a communication test. Specifically, acceptance of a job from another device via the communication line 12 (see FIG. 1) is disabled, setting change processing is executed on the first communication interface 21A, connection to the communication line 12 is established and communication check is performed, and then, connection to the communication line 12 is released and the original setting of the first communication interface 21A is restored.

In step S166, the CPU 27A displays communication result information of the communication test in S164 on the operation screen 22 (see FIG. 1). Note that the communication result information is also displayed on the terminal screen 32 mirrored (see FIG. 1).

In step S168, the CPU 27A checks again whether the setting is to be changed. At this time, “change setting” or “reset” is displayed on the operation screen 22 and the terminal screen 32 (see FIG. 1). When “change setting” is selected (Yes), the processing proceeds to step S170, and the CPU 27A executes the setting change processing. When “Reset” is selected, that is, when the setting is not to be changed (No), the processing returns to step S160.

### Processing in Mobile Terminal Device

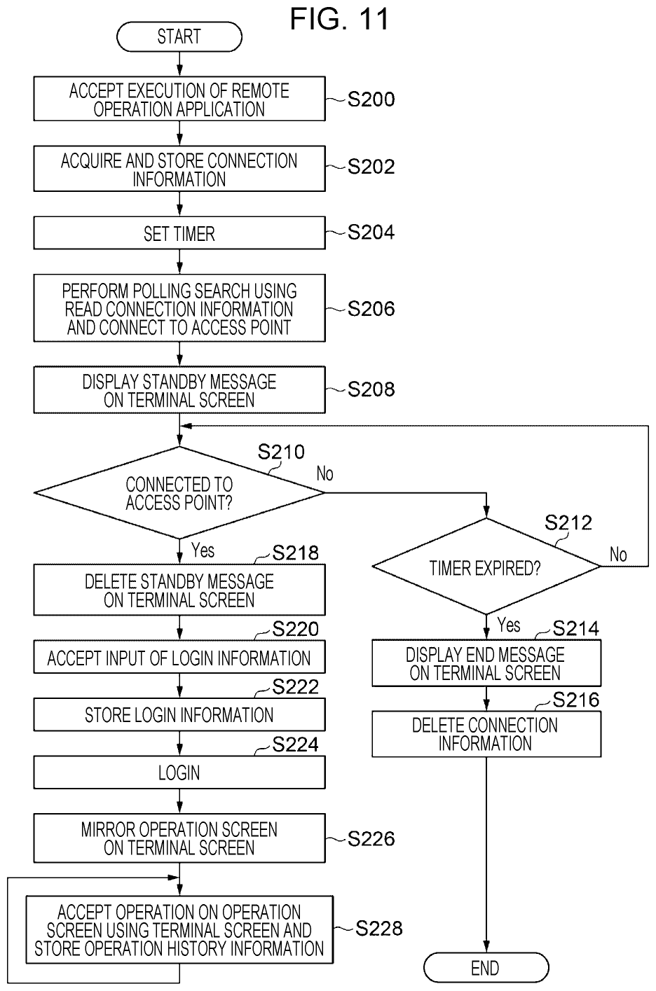

Next, remote operation processing in the mobile terminal device 30 will be described with reference to a flowchart in FIG. 11.

In step S200, the CPU 37A (see FIG. 5) of the control unit 38 of the mobile terminal device 30 accepts the execution of the remote operation application. In Step S202, the CPU 37A acquires and stores connection information as a result of reading the matrix-type two-dimensional code displayed on the operation screen 22 of the image forming apparatus 20, by the operator PA (see FIG. 6) using the camera of the mobile terminal device 30.

In step S204, the CPU 37A sets a timer. In step S206, the CPU 37A performs polling search with the read connection information and connects to the access point 26 (see FIG. 1). In step S208, the CPU 37A displays on the terminal screen 32, the standby message such as “Currently connected to access point. Please wait”.

In step S210, the CPU 37A checks whether the connection to the access point 26 is established. When the connection is not established (No), the processing proceeds to step S212. In step S212, the CPU 37A checks whether the timer has expired. When the timer has not expired yet (No), the processing returns to step S210. When the timer has expired in step S212 (Yes), the processing proceeds to step S214.

In step S214, the CPU 37A deletes the above-described standby message displayed on the terminal screen 32 (see FIG. 1), displays the end message such as “connection to access point failed”, and proceeds to step S216. In step S216, the CPU 37A deletes the stored connection information.

In step S214, a guide message for a countermeasure against the time-out may also be displayed. For example, the countermeasure is display indicating that when the time-out of the image forming apparatus 20 (see FIG. 1) occurs, the remote operation mode ends, and the setting before the execution of the remote operation mode is restored automatically. Alternatively, the countermeasure is display prompting the user to directly operate the operation screen 22 (see FIG. 1) of the image forming apparatus 20 to perform the restoration operation.

When the connection with the access point 26 (see FIG. 1) is established in step S210 described above (Yes), the processing proceeds to step S218. In step S218, the CPU 37A deletes the standby message on the terminal screen 32. In step S220, the CPU 37A accepts the login information input by the operator PA (see FIG. 6). In step S222, the CPU 37A stores the login information.

In step S224, the CPU 37A logs in to the image forming apparatus 20 (see FIG. 1) in which the remote operation mode is active, with the login information. In step S226, the CPU 37A mirrors the operation screen 22 of the image forming apparatus 20 to which he/she has logged in, on the terminal screen 32 (see FIG. 1).

In step S228, the CPU 37A accepts the operation on the operation screen 22 using the terminal screen 32, and stores the operation screen, that is, stores the operation history information of the terminal screen 32 every time the terminal screen 32 is operated and a change is made.

As described later, when the logout instruction is accepted and the logout occurs, the processing ends. Alternatively, when the mobile terminal device 30 is not reconnected to the image forming apparatus 20 after the restart in response to the restart instruction, the processing ends. Until then, step S228 is repeated.

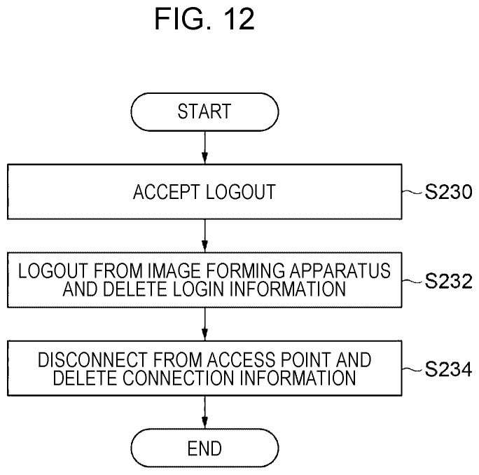

Next, processing executed when the logout instruction is accepted in step S228 (see FIG. 11) will be described with reference to a flowchart in FIG. 12.

In step S230, the CPU 37A accepts logout from the terminal screen 32 (see FIG. 1). In step S232, the CPU 37A logs out from the image forming apparatus 20 (see FIG. 1) and deletes the stored login information.

In step S234, the CPU 37A releases the connection with the access point 26 (see FIG. 1) dedicated to the remote mode of the image forming apparatus 20 and deletes the connection information. Note that the connection with the access point 26 of the image forming apparatus 20 may be already released due to logout. Also in such a case, the connection information is similarly deleted in such a case.

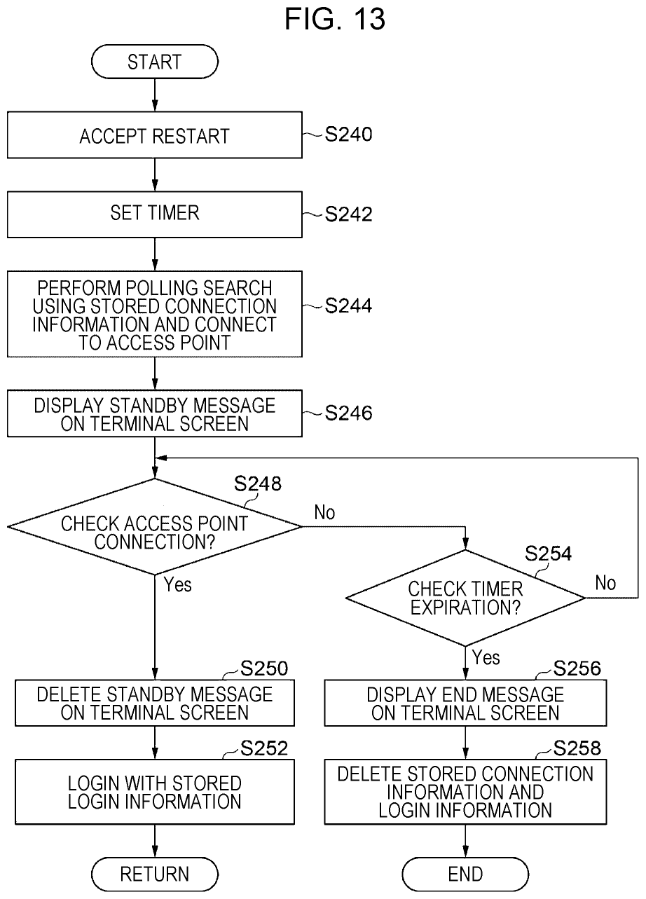

Next, processing executed when the image forming apparatus 20 (see FIG. 1) is restarted in step S228 (see FIG. 11) will be described with reference to a flowchart in FIG. 13.

In step S240, the CPU 37A accepts a restart operation. Disconnection from the access point 26 (see FIG. 1) occurs in response to the restart of the image forming apparatus 20.

In step S242, the CPU 37A sets a timer. In step S244, the CPU 37A performs polling search with the stored connection information and establishes connection with the access point 26. In step S246, the CPU 37A displays, on the terminal screen 32 (see FIG. 1), the standby message such as “Currently connected to access point. Please wait”.

In step S248, the CPU 37A checks whether the connection to the access point 26 is established. When the connection is established (Yes), the processing proceeds to step S250. In step S250, the CPU 37A deletes the standby message on the terminal screen 32 (see FIG. 1). Next, in step S252, the CPU 37A logs in to the image forming apparatus 20 with the stored login information, and returns to step S226 (see FIG. 11).

When the connection with the access point 26 is not established in step S248 (No), the CPU 37A proceeds to step S254. In step S254, it is determined whether the timer has expired. When the timer has not expired yet (No), the processing returns to step S248. When the timer has expired (Yes), the processing proceeds to step S256.

In step S256, the CPU 37A deletes the standby message and displays the end message such as “connection to access point failed” on the terminal screen 32. In step S258, the CPU 37A deletes the connection information and the login information stored.

In step S256, a guide message for a countermeasure may also be displayed. For example, the countermeasure is display indicating that when the time-out of the image forming apparatus 20 occurs, the remote operation mode ends, and the setting before the execution of the remote operation mode is restored automatically. Alternatively, display may be provided prompting the user to perform a restoration operation by operating the operation screen 22 of the image forming apparatus 20.

When the setting change for the first communication interface 21A (see FIG. 2) is accepted in step S228 (see FIG. 11), disconnection from or reconnection to the access point 26 or the like does not occur, reconnected. Thus, the description of such a case using a flowchart will be omitted.

### Operation

Next, operation of the present exemplary embodiment will be described.

After the image forming apparatus 20 is restarted by the remote operation using the mobile terminal device 30, the mobile terminal device 30 automatically performs polling search for and reconnects to the access point 26, and performs re-login, and further traces back to the screen before the restart based on the operation history information and restores the state before the restart. Therefore, the number of operations by the operator PA is reduced as compared with a case where the operator PA implements restoration by operating the operation screen 22 of the image forming apparatus 20 after the restart.

Further, the remote operation using the mobile terminal device 30 can be performed at a location away from the image forming apparatus 20, for example, at a desk while sitting on a chair, as long as the connection with the access point 26 can be established. Therefore, the operator PA can enjoy a higher degree of freedom in terms of operation as compared with a case where the operator PA operates the operation screen 22 of the image forming apparatus 20.

Further, the operator PA changes the setting of the image forming apparatus 20 through a remote operation using the mobile terminal device 30. Therefore, the number of times the operator PA needs to touch the operation screen 22 of the image forming apparatus 20 can be reduced. This is, for example, desirable from the viewpoint of sanitary management, under epidemic of infectious disease such as flu or new coronavirus.

Furthermore, the mobile terminal device 30 directly connects to the access point 26 dedicated to remote operation for the image forming apparatus 20. Therefore, security is improved as compared with a case where the mobile terminal device 30 is connected to the image forming apparatus 20 via the communication line 12.

Furthermore, communication check is performed by temporarily connecting to the communication line 12 using the first communication interface 21A whose setting has been changed, and the communication result is displayed on the mobile terminal device 30. Therefore, it is possible to perform communication check for the first communication interface 21A whose setting has been changed, which is difficult in a case where the mobile terminal device 30 is connected to the image forming apparatus 20 via the communication line 12.

Further, while the remote operation mode is active, acceptance of a job such as a print job from an external peripheral device such as a personal computer connected to the communication line 12 is disabled. Therefore, the job accepted during the communication check performed by temporarily connecting to the communication line 12 is not stopped due to the re-disconnection from the communication line.

Furthermore, the mobile terminal device 30 reads the matrix-type two-dimensional code displayed on the operation screen 22 of the image forming apparatus 20 and acquires the connection information for connecting to the access point 26. Therefore, as compared with a case where the connection information is displayed as text information on the operation screen 22 and the operator PA manually inputs the text information to the mobile terminal device 30, the number of operations by the operator PA is reduced and security is improved.

Once the mobile terminal device 30 is connected to the access point 26, the matrix-type two-dimensional code displayed on the operation screen 22 of the image forming apparatus 20 is deleted. Therefore, security is improved as compared with a case where the matrix-type two-dimensional code displayed on the operation screen 22 continues to be displayed.

Further, the image forming apparatus 20 only permits the login using the login information of the operator PA such as the administrator who has the authority to change the setting of the image forming apparatus 20. Therefore, security is improved as compared with a case where login is always permitted regardless of authority.

### Setting Change of Plurality of Image Forming Apparatuses

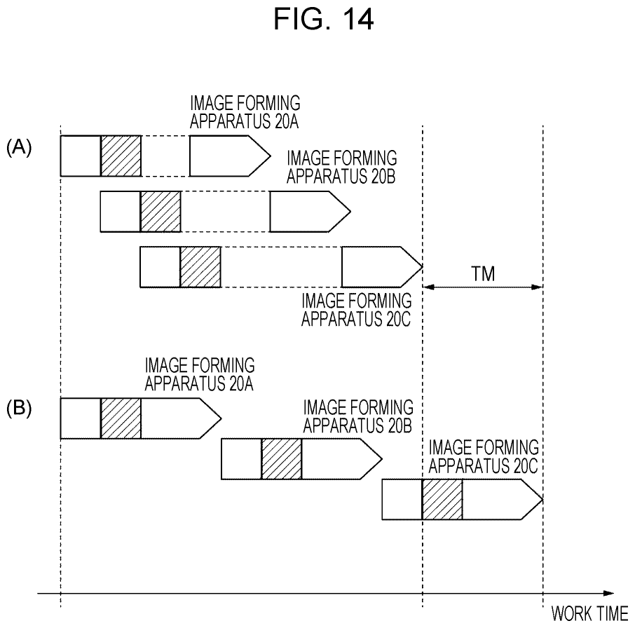

A case where the operator PA changes the setting of a plurality of image forming apparatuses 20 will be described with reference to (A) of FIG. 14. In the present description, for simplicity, the description will be given using three image forming apparatuses, that is, an image forming apparatus 20A, an image forming apparatus 20B, and an image forming apparatus 20C. In a case such as that where the image forming apparatus 20A, the image forming apparatus 20B, and the image forming apparatus 20C do not need to be distinguished from each other, A, B, and C after the reference numeral 20 are appropriately omitted in the description.

The mobile terminal device 30 stores and manages the connection information, the login information, and the operation history information in association with each of the image forming apparatus 20A, the image forming apparatus 20B, and the image forming apparatus 20C. Specifically, a unique number such as a MAC address is included in the connection information for the image forming apparatus 20. The mobile terminal device 30 stores and manages each information in association with a unique number, such as a MAC address, for each of the image forming apparatus 20A, the image forming apparatus 20B, and the image forming apparatus 20C. As described above, the connection information, the login information, and the operation history information are stored in the server 50 in association with the image forming apparatuses 20A, 20B, and 20C.

Note that when the operator PA changes the settings of the plurality of image forming apparatuses 20 in parallel, the operator PA operates the operation screen 22 of the image forming apparatus 20 and the terminal screen 32 of the mobile terminal device 30 to execute processing for disabling the control to cause time-out even when connection to the access point 26 fails.

The operator PA changes the settings while switching the image forming apparatus whose settings are to be changed using the mobile terminal device 30, among the image forming apparatuses 20A, 20B, and 20C. Specifically, as illustrated in (A) of FIG. 14, when the image forming apparatus 20A is restarted due to the setting change, the operator PA connects the mobile terminal device 30 to the image forming apparatus 20B, logs in, and changes the setting. Note that the connection information, the login information, and the operation history information of the image forming apparatus 20A are stored. Also when the image forming apparatus 20B or 20C are restarted thereafter, the connection information, the login information, and the operation history information of the image forming apparatus 20B or 20C are similarly stored.

Next, when the image forming apparatus 20B is restarted due to the setting change, the operator PA connects the mobile terminal device 30 to the image forming apparatus 20C, logs in, and changes the setting. Similarly, the connection information, login information, and operation history information of the image forming apparatus 20A are stored.

Then, when the image forming apparatus 20C is restarted due to setting change, the operator PA connects the mobile terminal device 30 to the access point 26 of the image forming apparatus 20A waiting for restart connection. At this time, the operator PA operates the terminal screen 32 to issue an instruction for reconnection to the access point 26 of the image forming apparatus 20A. As a result, the mobile terminal device 30 automatically performs polling search for and reconnection to the access point 26 of the image forming apparatus 20A and re-login using the connection information, the login information, and the operation history information of the image forming apparatus 20A, and further traces back to the screen before the restart based on the operation history information and restores the state before the restart.

Similarly, also for the access points 26 of the image forming apparatuses 20B and 20C which are in a state of waiting for restart connection, the operator PA operates the terminal screen 32 to issue the instruction for reconnection to the access points 26 of the image forming apparatus 20B and 20C, thus automatically performs polling search for and reconnection to the access points 26 of the image forming apparatus 20B and 20C, and re-login, and further traces back to the screen before the restart based on the operation history information and restores the state before the restart.

### Operation

Next, operation of the present exemplary embodiment will be described.

After the image forming apparatuses 20A, 20B, and 20C are restarted by the remote operation using the mobile terminal device 30, the mobile terminal device 30 automatically performs polling search for and reconnection to the access point 26 and performs re-login, and further traces back to the screen before the restart based on the operation history information and restores the state before the restart. Therefore, the number of operations by the operator PA is reduced as compared with a case where the operator PA implements restoration by operating the operation screen 22 of the image forming apparatus 20 after the restart.

Further, the remote operation using the mobile terminal device 30 can be performed at a location away from the image forming apparatuses 20A, 20B, and 20C, for example, at a desk while sitting on a chair, as long as connection with the access point 26 can be established. Therefore, the operator PA can enjoy a higher degree of freedom in terms of operation as compared with a case where the operator PA operates the operation screen 22 of the image forming apparatus 20.

If there is a work place where the image forming apparatuses 20A, 20B, and 20C are located close to each other and connection to all of the three access points 26 can be established, the operator PA may first read the connection information of all of the image forming apparatuses 20A, 20B, and 20C, and perform the setting operation while appropriately switching the connection among the image forming apparatuses 20A, 20B, and 20C in the work place.

Further, the operator PA changes the setting of a plurality of the image forming apparatuses 20A, 20B, and 20C through a remote operation using one mobile terminal device 30. Therefore, the number of times the operator PA needs to touch the operation screen 22 of the image forming apparatuses 20A, 20B, and 20C can be reduced. This is, for example, desirable from the viewpoint of sanitary management, under epidemic of infectious disease such as flu or new coronavirus.

In addition, since the setting change of another image forming apparatus 20 can be performed during the waiting time until the image forming apparatus 20 restarts, the entire working time of the operator PA can be reduced.

(B) of FIG. 14 illustrates a case where the setting is changed in the order of the image forming apparatus 20A, the image forming apparatus 20B, and the image forming apparatus 20C. (A) of FIG. 14 illustrates a case where the setting is changed by connecting to the image forming apparatus 20A while the image forming apparatus 20B is being restarted, and the setting is changed by connecting to the image forming apparatus 20B while the image forming apparatus 20C is being restarted. Comparison between (A) and (B) of FIG. 14 indicates reduction of the entire working time of the operator PA by a time TM.

### Others

The present disclosure is not limited to the above-described exemplary embodiment.

For example, in the above-described exemplary embodiment, the connection information for connecting to the access point 26 of the image forming apparatus 20 is acquired by displaying a matrix-type two-dimensional code with the connection information on the operation screen 22 and reading the matrix-type two-dimensional code by the mobile terminal device 30 using the camera, but this should not be construed in a limiting sense. The connection information for connecting to the access point 26 of the image forming apparatus 20 may be presented in other ways. For example, the IC card of the mobile terminal device 30 may be brought close to the card reader 24 of the image forming apparatus 20 to acquire the connection information. Also in this case, the CPU 27A controls the second communication interface 21B so that connection information cannot be read from the card reader 24 once connection with the access point 26 is established. Furthermore, the connection information may be presented to the mobile terminal device 30 in a way other than those using the matrix-type two-dimensional code and the card reader 24. For example, the connection information may be displayed as text information on the operation screen 22.

Furthermore, for example, while the mobile terminal device 30 is directly connected to the access point 26 of the image forming apparatus 20 and the connection with the communication line 12 is released in the above exemplary embodiment, this should not be construed in a limiting sense. The mobile terminal device 30 may be connected to the image forming apparatus 20 via the communication line 12. In this case, the image forming apparatus 20 does not accept a job from the external device while the remote operation mode is active. Further, when the image forming apparatus 20 is restarted, reconnection to the image forming apparatus 20 via the communication line 12 is established for re-login, and the screen before the restart is traced back based on the operation history information to restore the state before the restart.

Further, for example, in the above-described exemplary embodiment, the time-out of the mobile terminal device 30 occurs and the connection processing ends when a preset time elapses, but this should not be construed in a limiting sense. For example, an upper limit may be set for the number of times the polling search can be performed, and the connection processing may be terminated when the upper limit is reached.

In addition, for example, the configuration of the image forming apparatus 20, the configuration of the mobile terminal device 30, and the configuration of the server 50 described in the above-described exemplary embodiment are merely examples, and may be changed or a new component may be added according to a situation without departing from the gist.

Furthermore, for example, while the mobile terminal device 30 and the server 50 execute the remote operation application in cooperation with each other in the above exemplary embodiment, only the mobile terminal device 30 may execute the remote operation application. Furthermore, the image forming apparatus 20 and a server or the like connected to the communication line 12 may cooperate to execute the remote operation mode. Furthermore, an information device system other than the image forming apparatus 20 may be employed. The information device system may be anything enabling setting change with an operation screen mirrored on a terminal screen of a mobile terminal system, and may be a personal computer, a vending machine, and the like for example.

In addition, the flow of the processing of the program described in the above-described exemplary embodiment is an example, and an unnecessary step may be deleted, a new step may be added, or the processing order may be changed without departing from the gist.

In the above-described exemplary embodiment, the case where the processing according to the exemplary embodiment is realized by a software configuration using a computer executing a program has been described, but this should not be construed in a limiting sense. The exemplary embodiment may be implemented by, for example, a hardware configuration or a combination of a hardware configuration and a software configuration.

The operation of the processor in the above-described exemplary embodiment may be performed not only by one processor but also through cooperations of a plurality of processors which are located at physically separated positions. In addition, the order of the operations of the processor is not limited to only the order described in the exemplary embodiments described above but may be appropriately changed.

Further, the present disclosure can be carried out in various modes without departing from the gist of the present invention.

### Appendix

(((1))) A mobile terminal system comprising:
one or more processors configured to:
establish connection, using connection information, with an information device system executing a remote operation mode under which an operation screen of the information device system is mirrored on a terminal screen to enable a remote operation on the operation screen
logs in to the information device system using login information input and store the login information;
store an operation history of the terminal screen;
when the information device system is restarted and the connection is released,
   reconnect to the restarted information device system using the connection information;
   log in to the information device system using the login information stored; and
   restore the terminal screen at a timing of the release using the operation history stored.
      (((2))) The mobile terminal system according to (((1))), wherein the processor is configured to connect to an access point for the remote operation, activated when the information device system executes the remote operation mode.
      (((3))) The mobile terminal system according to (((2))), wherein the processor is configured to:
instruct the information device system to change a setting of a communication interface;
instruct the information device system to check communications with a communication line through the communication interface whose setting has been changed; and
accept a communication result.
   (((4))) The mobile terminal system according to any one of (((1))) to (((3))), wherein the processor is configured to:
acquire the connection information from the information device system; and
store the acquired connection information.
   (((5))) The mobile terminal system according to (((4))), wherein the processor is configured to acquire the connection information by reading a matrix-type two-dimensional code displayed on the operation screen in response to the information device system executing the remote operation mode.
   (((6))) The mobile terminal system according to (((4))), wherein the processor acquires the connection information from the information device system through short-range wireless communications.
   (((7))) The mobile terminal system according to any one of (((1))) to (((6))), wherein the processor is configured to display a countermeasure on the terminal screen when the mobile terminal system fails to reconnect to the information device system within a set time.
   (((8))) An information device system comprising:
one or more processors configured to:
accept execution of a remote operation mode under which an operation screen is mirrored on a terminal screen of a connected mobile terminal system to enable a remote operation on the operation screen using the mobile terminal system;
accept login using login information of the connected mobile terminal system;
accept login using the login information of the mobile terminal system reconnecting, after restart in response to acceptance of a restart instruction from the mobile terminal system; and
end the execution of the remote operation mode in response to acceptance of logout of the mobile terminal system.
   (((9))) The information device system according to (((8))), wherein when the execution of the remote operation mode is accepted, the processor is configured to:
disconnect from a communication line and activates an access point for remote operation to which the mobile terminal system is connected;
accept login based on the login information of the mobile terminal system connected to the access point;
restart the access point upon restarting in response to acceptance of a restart instruction from the mobile terminal system;
accept login based on the login information of the mobile terminal system reconnected to the access point; and
in response to acceptance of logout of the mobile terminal system, end the execution of the remote operation mode, connect to the communication line, and deactivate the access point.
   (((10))) The information device system according to (((9))), wherein, when an instruction for the execution of the remote operation mode is accepted, the processor is configured to:
store a setting before the execution before executing the remote operation mode; and
when the mobile terminal system fails to be connected to the access point within a set time, end the execution of the remote operation mode and restore the setting before the execution.
   (((11))) The information device system according to (((9))) or (((10))), wherein the processor is configured to present connection information for connecting to the access point acquired by the mobile terminal system, in response to acceptance of the execution of the remote operation mode.
   (((12))) The information device system according to (((11))), wherein when the execution of the remote operation mode is accepted, the processor is configured to display, on the operation screen, a matrix-type two-dimensional code with the connection information.
   (((13))) The information device system according to (((11))), wherein the processor is configured to present the connection information through short-range wireless communications in response to acceptance of the execution of the remote operation mode.
   (((14))) The information device system according to any one of (((11))) to (((13))), wherein the processor is configured to end the presentation of the connection information once the mobile terminal system is connected to the access point.
   (((15))) The information device system according to any one of (((9))) to (((14))), wherein, when an instruction to check communications with the communication line is accepted, the processor is configured to: connect to the communication line, check the communications, and transmit a communication result to the mobile terminal system; and disconnect from the communication line again.
   (((16))) The information device system according to (((15))), wherein the processor is configured not to accept a job from an external device through the communication line.
   (((17))) The information device system according to any one of (((8))) to (((16))), wherein the processor is configured to only permit login using the login information that is registered.
   (((18))) A program causing a mobile terminal system as a computer, which connects to an information device system executing a remote operation mode under which an operation screen of the information device system is mirrored on a terminal screen to enable a remote operation on the operation screen, to execute a process comprising:
connecting to the information device system using connection information; logging in to the information device system using login information input and storing the login information;
storing an operation history of the terminal screen, and when the information device system is restarted and the connection is released;
reconnecting to the restarted information device system using the connection information;
logging in to the information device system using the login information stored; and
restoring, using the stored operation history, the terminal screen at a point when the connection is released.

What is claimed is:

1. A mobile terminal system comprising:
one or more processors configured to:
establish connection, using connection information, with an information device system executing a remote operation mode under which an operation screen of the information device system is mirrored on a terminal screen to enable a remote operation on the operation screen;
log in to the information device system using login information input and store the login information;
store an operation history of the terminal screen;
when the information device system is restarted and the connection is released,
reconnect to the restarted information device system using the connection information;
log in to the information device system using the login information stored; and
restore the terminal screen at a timing of the release using the operation history stored.

2. The mobile terminal system according to claim 1, wherein the processor is configured to connect to an access point for the remote operation, activated when the information device system executes the remote operation mode.

3. The mobile terminal system according to claim 2, wherein the processor is configured to:
instruct the information device system to change a setting of a communication interface;
instruct the information device system to check communications with a communication line through the communication interface whose setting has been changed; and
accept a communication result.

4. The mobile terminal system according to claim 1, wherein the processor is configured to:
acquire the connection information from the information device system; and
store the acquired connection information.

5. The mobile terminal system according to claim 4, wherein the processor is configured to: acquire the connection information by reading a matrix-type two-dimensional code displayed on the operation screen in response to the information device system executing the remote operation mode.

6. The mobile terminal system according to claim 4, wherein the mobile terminal system acquires the connection information from the information device system through short-range wireless communication.

7. The mobile terminal system according to claim 1, wherein the processor is configured to display a countermeasure on the terminal screen when the mobile terminal system fails to reconnect to the information device system within a set time.

8. An information device system comprising:
one or more processors configured to:
accept execution of a remote operation mode under which an operation screen is mirrored on a terminal screen of a connected mobile terminal system to enable a remote operation on the operation screen using the mobile terminal system;
accept login using login information of the connected mobile terminal system;
accept login using the login information of the mobile terminal system reconnecting, after restart in response to acceptance of a restart instruction from the mobile terminal system; and
end the execution of the remote operation mode in response to acceptance of logout of the mobile terminal system.

9. The information device system according to claim 8, wherein when the execution of the remote operation mode is accepted, the processor is configured to:
disconnect from a communication line and activates an access point for remote operation to which the mobile terminal system is connected;
accept login based on the login information of the mobile terminal system connected to the access point;
restart the access point upon restarting in response to acceptance of a restart instruction from the mobile terminal system;
accept login based on the login information of the mobile terminal system reconnected to the access point; and
in response to acceptance of logout of the mobile terminal system, end the execution of the remote operation mode, connects to the communication line, and deactivate the access point.

10. The information device system according to claim 9, wherein, when an instruction for the execution of the remote operation mode is accepted, the processor is configured to:
store a setting before the execution before executing the remote operation mode; and
when the mobile terminal system fails to be connected to the access point within a set time, end the execution of the remote operation mode and restore the setting before the execution.

11. The information device system according to claim 9, wherein the processor is configured to present connection information for connecting to the access point acquired by the mobile terminal system, in response to acceptance of the execution of the remote operation mode.

12. The information device system according to claim 11, wherein when the execution of the remote operation mode is accepted, the processor configured to display, on the operation screen, a matrix-type two-dimensional code with the connection information.

13. The information device system according to claim 11, wherein the processor is configured to present the connection information through short-range wireless communications in response to acceptance of the execution of the remote operation mode.

14. The information device system according to claim 11, wherein the processor is configured to end the presentation of the connection information once the mobile terminal system is connected to the access point.

15. The information device system according to claim 9, wherein, when an instruction to check communications with the communication line is accepted, the processor is configured to:
connect to the communication line, checks the communications, and transmit a communication result to the mobile terminal system; and
disconnect from the communication line again.

16. The information device system according to claim 15, wherein the processor is configured not to accept a job from an external device through the communication line.

17. The information device system according to claim 8, wherein the processor is configured to only permit login using the login information that is registered.

18. A non-transitory computer readable storage medium storing a program causing a mobile terminal system as a computer, which connects to an information device system executing a remote operation mode under which an operation screen of the information device system is mirrored on a terminal screen to enable a remote operation on the operation screen, to execute a process comprising:
connecting to the information device system using connection information; logging in to the information device system using login information input and storing the login information;
storing an operation history of the terminal screen, and when the information device system is restarted and the connection is released;
reconnecting to the restarted information device system using the connection information;
logging in to the information device system using the login information stored; and
restoring, using the stored operation history, the terminal screen at a point when the connection is released.
